(19) United States
(12) Patent Application Publication
(10) Pub. No.: US 2026/0064849 A1
(43) Pub. Date: Mar. 5, 2026

(54) Real-Time Artificial Intelligence Model Vulnerability Testing System

(71) Applicant: Bank of America Corporation, Charlotte, NC (US)

(72) Inventors: Shailendra Singh, Maharashtra (IN); Sindu Puthenvarium Sreedevi, Maharashtra (IN); Vasudev Bhanu Rasam, Maharashtra (IN)

(73) Assignee: Bank of America Corporation, Charlotte, NC (US)

(21) Appl. No.: 18/823,240

(22) Filed: Sep. 3, 2024

(51) Int. Cl. G06F 21/57

(52) U.S. Cl. CPC G06F 21/577; G06F 2221/033

(57) ABSTRACT

Various aspects of the disclosure relate to automated real-time penetration testing of artificial intelligence (AI) models used by AI-based applications. A real-time AI model penetration testing plugin orchestrates real-time penetration testing for scanning and detecting vulnerabilities in AI model-based applications, particularly those applications leveraging generative AI algorithms. A plugin installation on a user device automatically scans AI model-based application operations hosted locally to the user device and/or centrally located on a remote server and provides a degree of confidence and trust corresponding to use of the AI model-based application. The plugin orchestrates security scans before all transactions and/or tasks executed by the AI application and initiates a security response based on a trust score corresponding to penetration test results.

### BACKGROUND

Large organizations, such as financial institutions and other large enterprise organizations, may provide many different products and/or services. To support these complex and large-scale operations, a large organization may own, operate, and/or maintain many different computer systems that service different internal users and/or external users in connection with different products and services. In addition, some computer systems internal to the organization may be configured to exchange information with computer systems external to the organization so as to provide and/or support different products and services offered by the organization.

As a result of the complexity associated with the operations of a large organization and its computer systems, it may be difficult for such an organization, such as a financial institution, to manage its computer systems efficiently, effectively, securely, and uniformly, and particularly manage how internal computer systems exchange information with external computer systems in providing and/or supporting different products and services offered by the organization.

### SUMMARY

The following presents a simplified summary in order to provide a basic understanding of some aspects of the disclosure. The summary is not an extensive overview of the disclosure. It is neither intended to identify key or critical elements of the disclosure nor to delineate the scope of the disclosure. The following summary presents some concepts of the disclosure in a simplified form as a prelude to the description below.

Aspects of the disclosure relate to computer systems that provide effective, efficient, scalable, and convenient ways of securely and uniformly managing how internal computer systems exchange information with external computer systems to provide and/or support different products and services offered by an organization (e.g., a financial institution, and the like).

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions. One general aspect includes real-time testing and analysis of artificial intelligence-based models processed by one or more applications.

Aspects of the disclosure relate to computer hardware and software. In particular, one or more aspects of the disclosure generally relate to computer hardware and software for orchestrating real-time penetration testing to scan and detect vulnerabilities in artificial intelligence (AI) model-based applications.

A need has been recognized to ensure AI-based products are secure for consumer applications and, more particularly, to allow consumer products to self-evaluate AI applications, such as to ensure AI model security. For example, the systems and methods discussed below involve procedures for orchestrating real-time penetration testing for scanning and detecting vulnerabilities in AI model-based applications, particularly those applications leveraging generative AI algorithms. In some cases, each installation on a user device may allow an end user (either manually or automatically) to initiate a scan of AI model-based applications hosted locally to the user device and/or centrally located on a remote server. This local testing capability provides a degree of confidence and trust to the user regarding use of the AI model-based product. The system may include a scanning plugin installed on an end device (computing machine, computer, mobile device, spatial computing device, and the like). This plugin interacts with one or more AI applications installed on the device and orchestrates security scans before all transaction/task executed by the AI application/product.

In some cases, an AI-model scanning system may interact with each AI model that is hosted on the client computing device and/or on the server side and extracts data and metadata telemetry corresponding to AI model operations and resources. For example, the extracted data may include one or more of cache information, application programming interface (API) calls and/or responses, end point information, training data source information, computing infrastructure information, data storage server information, edge computing infrastructure information, information corresponding to additional software application(s) supporting model execution, information metadata, and the like). Data extracted by an analysis engine during the scan is parsed into a neuro-symbolic AI engine that enhances and/or generates new penetration testing conditions (e.g., a configuration file) or scenario (e.g., one or more test cases) through analysis of data and metadata telemetry corresponding to AI model functioning and resource use.

The generated penetration testing scenarios or conditions may be executed in real-time and coordinated with the computing device on which model is hosted. Results of the penetration tests may be used to generate an AI model trust score. For example, a score less than a threshold may cause the computing device disable execution of the AI application and/or generate a security alert to the user. In some cases, the analysis engine may trigger an alert to a central monitoring system that, in turn, may trigger an automated analysis response that may include additional testing of the AI model. In some cases, the process may allow individual users to integrate their devices with other users to form a local area network, or analysis group, that can be used to relay trust scores to other devices and/or can engage other devices having similar AI applications to perform a joint penetration test linked to specific shared and/or common AI applications or AI models.

In some cases, the real-time artificial intelligence model vulnerability testing system enables individual computing devices to trigger a webhook call to an AI model development central system (e.g., a machine learning operations (MLOps) system) based on the trust score generated thru penetration testing results. The webhook payload may include penetration testing result metadata that can be utilized by the MLOps system to identify, fix, or otherwise solve an identified security issue. In some cases, the webhook payload may be used to initiate an automated response to identify and/or resolve specific vulnerabilities. In some cases, a centralized AI model development and/or testing system (e.g., the MLOps system) may ingest a webhook payload, extract payload information, and automatically generate healing protocols by leveraging neuro-symbolic AI. The real-time artificial intelligence model vulnerability testing system, based on payload parameters received from one or more individual computing devices may utilize neuro-symbolic reasoning to formulate fixes for identified AI model vulnerabilities. In some cases, the real-time artificial intelligence model vulnerability testing system may generate a smart contract to manage penetration testing rules, test cases, and/or conditions, for use in future scan if device profile. In some cases, the real-time artificial intelligence model vulnerability testing system may trigger scanning of AI models and generate new trust scores based on AI product profile changes. In some cases, the real-time artificial intelligence model vulnerability testing system may identify changes or a latest smart contract in a blockchain or other distributed ledger system before initiating a scan of one or more AI models.

These features, along with many others, are discussed in greater detail below.

### BRIEF DESCRIPTION OF THE DRAWINGS

The present disclosure is illustrated by way of example and not limited in the accompanying figures in which like reference numerals indicate similar elements and in which:

FIG. 1A shows an illustrative computing environment for real-time vulnerability testing of AI models, in accordance with one or more aspects described herein;

FIG. 1B shows an illustrative computing platform enabled for real-time vulnerability testing of AI models, in accordance with one or more aspects described herein;

FIG. 2 shows illustrative real-time AI model vulnerability testing system in accordance with one or more aspects described herein;

FIG. 3 show an illustrative localized network-based real-time AI model vulnerability testing system, in accordance with one or more example arrangements;

FIG. 4 shows an illustrative penetration testing system in accordance with one or more aspects described herein; and

FIG. 5 shows an illustrative block diagram of an AI model penetration testing system in accordance with one or more aspects described herein.

### DETAILED DESCRIPTION

In the following description of various illustrative embodiments, reference is made to the accompanying drawings, which form a part hereof, and in which is shown, by way of illustration, various embodiments in which aspects of the disclosure may be practiced. It is to be understood that other embodiments may be utilized, and structural and functional modifications may be made, without departing from the scope of the present disclosure.

It is noted that various connections between elements are discussed in the following description. It is noted that these connections are general and, unless specified otherwise, may be direct or indirect, wired or wireless, and that the specification is not intended to be limiting in this respect.

As used throughout this disclosure, computer-executable “software and data” can include one or more: algorithms, applications, application program interfaces (APIs), attachments, big data, daemons, emails, encryptions, databases, datasets, drivers, data structures, file systems or distributed file systems, firmware, graphical user interfaces, images, instructions, machine learning (e.g., supervised, semi-supervised, reinforcement, and unsupervised), middleware, modules, objects, operating systems, processes, protocols, programs, scripts, tools, and utilities. The computer-executable software and data is on tangible, computer-readable memory (local, in network-attached storage, or remote), can be stored in volatile or non-volatile memory, and can operate autonomously, on-demand, on a schedule, and/or spontaneously.

“Computer machines” can include one or more: general-purpose or special-purpose network-accessible administrative computers, clusters, computing devices, computing platforms, desktop computers, distributed systems, enterprise computers, laptop or notebook computers, primary node computers, nodes, personal computers, portable electronic devices, servers, node computers, smart devices, tablets, and/or workstations, which have one or more microprocessors or executors for executing or accessing the computer-executable software and data. References to computer machines and names of devices within this definition are used interchangeably in this specification and are not considered limiting or exclusive to only a specific type of device. Instead, references in this disclosure to computer machines and the like are to be interpreted broadly as understood by skilled artisans. Further, as used in this specification, computer machines also include all hardware and components typically contained therein such as, for example, processors, executors, cores, volatile and non-volatile memories, communication interfaces, etc.

Computer “networks” can include one or more local area networks (LANs), wide area networks (WANs), the Internet, wireless networks, digital subscriber line (DSL) networks, frame relay networks, asynchronous transfer mode (ATM) networks, virtual private networks (VPN), or any combination of the same. Networks also include associated “network equipment” such as access points, ethernet adaptors (physical and wireless), firewalls, hubs, modems, routers, and/or switches located inside the network and/or on its periphery, and software executing on the foregoing.

The above-described examples and arrangements are merely some examples of arrangements in which the systems described herein may be used. Various other arrangements employing aspects described herein may be used without departing from the innovative concepts described.

In recent years, artificial intelligence, which is a term that can refer to a broad variety of technologies that uses artificial intelligence (AI) and/or machine learning (ML) algorithms for augmenting computing functions for decision making and/or analysis, has attracted an enormous amount of market and media attention. As such, a multitude of flurry of AI products have been deployed to hundreds of millions of people. Since then, reports about the potential harms of AI have increased causing governmental agencies, such as the Federal Trade Commission (FTC), and others to become interested in understanding consumer concerns and/or harms to consumers resulting from the increase use of AI across the computing environment. Because AI models require training before their use to allow the model to learn aspects of the particular application environment, today's AI models require massive amounts of data to accomplish this training. The power and breadth of these models, particularly when the training data may involve private or personally identifying information, have implications for both consumer protection and competition. Any vulnerability in one or more AI products using the AI models can lead to data security issues and/or faulty decision making for consumer applications. Currently no technical procedure exists that enables consumer devices utilizing AI products to self-evaluate an AI product or even scan AI products in real-time for any potential vulnerability before installation and/or operation of the AI product for any specific purpose. As such a need has been recognized for processes and applications that secure AI products for consumer installations and allow real-time evaluations of AI products for vulnerabilities and/or misuse.

AI model vulnerabilities may be introduced via training and/or high use scenarios. For example, an AI model may be trained by a malicious actor to generate vulnerabilities in the model that may allow the malicious actors access to the network and/or private or secure information within the network. The model may also be subject to high volume of queries that restrict the useful output of model, such as in a denial of service attack.

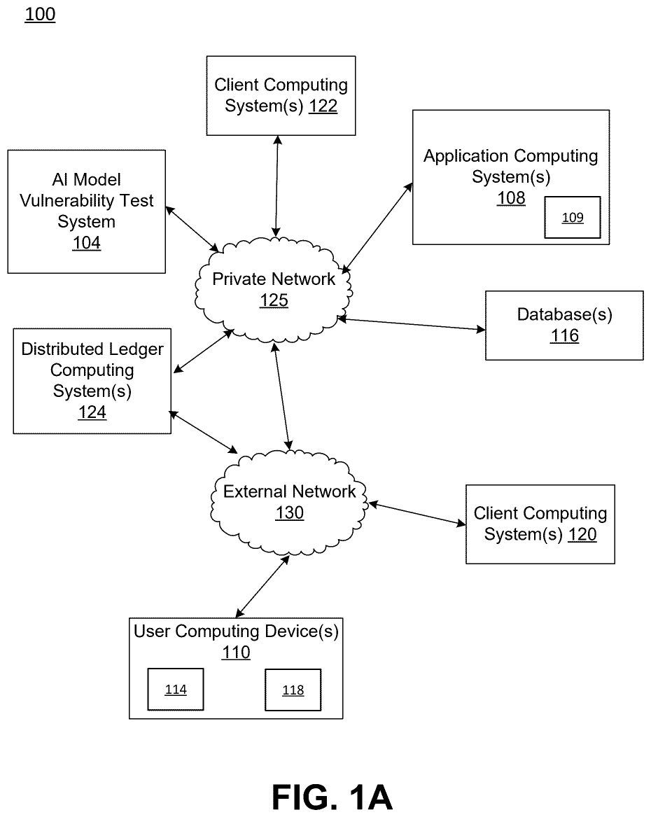

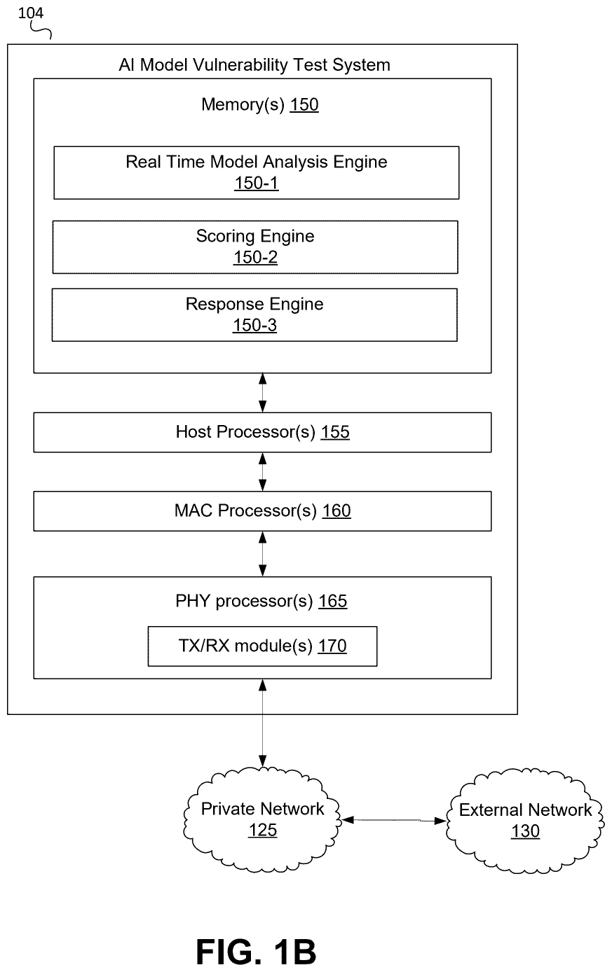

FIG. 1A shows an illustrative computing environment 100 for real-time AI model vulnerability testing, in accordance with one or more arrangements. The computing environment 100 may comprise one or more devices (e.g., computer systems, communication devices, and the like). The computing environment 100 may comprise, for example, an AI model vulnerability testing system 104, one or more application computing systems 108, one or more client computing systems 122, one or more distributed ledger computing systems 124, and/or one or more database(s) 116. The one or more of the devices and/or systems, may be linked over a private network 125 associated with an enterprise organization (e.g., a financial institution, a business organization, an educational institution, a governmental organization and the like). The computing environment 100 may additionally comprise a client computing systems 120, one or more of the distributed ledger computing systems 124, and one or more user devices 110 connected, via a public network 130, to the devices in the private network 125. The devices in the computing environment 100 may transmit/exchange/share information via hardware and/or software interfaces using one or more communication protocols. The communication protocols may be any wired communication protocol(s), wireless communication protocol(s), one or more protocols corresponding to one or more layers in the Open Systems Interconnection (OSI) model (e.g., local area network (LAN) protocol, an Institution of Electrical and Electronics Engineers (IEEE) 802.11 WIFI protocol, a 3^{rd} Generation Partnership Project (3GPP) cellular protocol, a hypertext transfer protocol (HTTP), etc.). While FIG. 1A shows the AI model vulnerability testing system 104 as a stand-alone system. In some cases, the AI model vulnerability testing system 104 may be incorporated within multiple computing systems, such as, for example, the application computing system(s) 108 and/or one or more user computing devices 110.

The AI model vulnerability testing system 104 may comprise one or more computing devices and/or other computer components (e.g., processors, memories, communication interfaces) configured to perform one or more functions as described herein. Further details associated with the architecture of the AI model vulnerability testing system 104 are described with reference to FIG. 1B.

The application computing systems 108 and/or the client computing systems 122 may comprise one or more computing devices and/or other computer components (e.g., processors, memories, communication interfaces). In addition, the application computing systems 108 and/or the client computing systems 122 may be configured to host, execute, and/or otherwise provide one or more enterprise applications. In some cases, the application computing systems 108 may host one or more services 109 configured facilitate operations requested through one or more API calls, such as data retrieval and/or initiating processing of specified functionality. In some cases, the client computing systems 122 may be configured to communicate with one or more of the application computing systems 108 such as via direct communications and/or API function calls and the services 109. In an arrangement where the private network 125 is associated with a financial institution (e.g., a bank), the application computing systems 108 may be configured, for example, to host, execute, and/or otherwise provide one or more transaction processing programs, such as an online banking application, fund transfer applications, and/or other programs associated with the financial institution. The client computing systems 122 and/or the application computing systems 108 may comprise various servers and/or databases that store and/or otherwise maintain account information, such as financial account information including account balances, transaction history, account owner information, and/or other information. In addition, the client computing systems 122 and/or the application computing systems 108 may process and/or otherwise execute transactions on specific accounts based on commands and/or other information received from other computer systems comprising the computing environment 100. In some cases, one or more of the client computing systems 122 and/or the application computing systems 108 may be configured, for example, to host, execute, and/or otherwise provide one or more transaction processing programs, such as electronic fund transfer applications, online loan processing applications, and/or other programs associated with the financial institution.

The application computing systems 108 may be one or more host devices (e.g., a workstation, a server, and the like) or mobile computing devices (e.g., smartphone, tablet). In addition, an application computing systems 108 may be linked to and/or operated by a specific enterprise user (who may, for example, be an employee or other affiliate of the enterprise organization) who may have administrative privileges to perform various operations within the private network 125. In some cases, the application computing systems 108 may be capable of performing one or more layers of user identification based on one or more different user verification technologies including, but not limited to, password protection, pass phrase identification, biometric identification, voice recognition, facial recognition and/or the like. In some cases, a first level of user identification may be used, for example, for logging into an application or a web server and a second level of user identification may be used to enable certain activities and/or activate certain access rights.

The client computing systems 120 may comprise one or more computing devices and/or other computer components (e.g., processors, memories, communication interfaces). The client computing systems 120 may be configured, for example, to host, execute, and/or otherwise provide one or more transaction processing programs, such as goods ordering applications, electronic fund transfer applications, online loan processing applications, and/or other programs associated with providing a product or service to a user. With reference to the example where the client computing systems 120 is for processing an electronic exchange of goods and/or services. The client computing systems 120 may be associated with a specific goods purchasing activity, such as purchasing a vehicle, transferring title of real estate may perform communicate with one or more other platforms within the client computing systems 120. In some cases, the client computing systems 120 may integrate API calls to request data, initiate functionality, or otherwise communicate with the one or more application computing systems 108, such as via the services 109. For example, the services 109 may be configured to facilitate data communications (e.g., data gathering functions, data writing functions, and the like) between the client computing systems 120 and the one or more application computing systems 108.

The user device(s) 110 may be computing devices (e.g., desktop computers, laptop computers) or mobile computing device (e.g., smartphones, tablets) connected to the network 125. The user device(s) 110 may be configured to enable the user to access the various functionalities provided by the devices, applications, and/or systems in the network 125. For example, the computing devices may execute one or more applications, such as application 114, that may utilize one or more artificial intelligence and/or machine learning models during operation, where the AI model may cause the application 114 to exchange data with one or more computing systems (e.g., the application computing systems 108, the client computing system 120, the client computing systems 122, and/or the like, such as via application programming interface (API) calls. In some cases, the user computing device may utilize another application and/or other executable code (e.g., a plugin) to enable real-time analysis and/or monitoring of AI model utilization and/or operation. For example, a real-time AI model application penetration plugin 118 may be used to analyze and/or monitor AI model operation before each access and/or use of the AI model by the application 114. Operation and/or utilization of the real-time AI model application penetration plugin 118 will be discussed in greater detail below.

The database(s) 116 may comprise one or more computer-readable memories storing information that may be used by the AI model vulnerability test system 104. For example, the database(s) 116 may store AI model trust scores, neuro-symbolic analysis information, webhook information, API call and/or response information, metadata associated with stored information, device profile information, metadata telemetry information, system information, hardware information, model execution information, penetration test case information, penetration test result information, static application security test information, interactive application security test information, data log information, telemetry information, identified vulnerability information, vulnerability pattern information, and/or the like. In an arrangement, the database(s) 116 may be used for other purposes as described herein. In some cases, the client computing systems 120 may write data or read data to the database(s) 116 via the services 109.

The decentralized ledger computing system 124 provided herein is described, at least in part, in relation to a decentralized peer-to-peer (e.g., P2P) system specialized for the purpose of managing a blockchain and/or other distributed ledger structure. The decentralized P2P system may be comprised of computing devices that are distributed in multiple locations across a geographical area as opposed to a single location. The computing devices forming the decentralized P2P system may operate with each other to manage a blockchain, which may be a data structure used to store information related to the decentralized P2P system. More specifically, the blockchain may be a chronological linkage of data elements (e.g., blocks) which store data records relating to the decentralized computing system.

A user, such as an individual, an application, and/or a computing system, may access the decentralized P2P system through a specialized “wallet” or other data structure that serves to uniquely identify the user and enable the user to perform functions related to the decentralized P2P network. Through the wallet, the user may be able to hold tokens, funds, process rules and/or associated computing functionality and/or any other asset associated with the decentralized P2P system. Furthermore, the user may be able to use the wallet to request performance of network-specific functions related to the decentralized P2P system such as rule processing, data, fund, token, and/or asset transfers, and/or the like. The various computing devices forming the decentralized P2P computing system may operate as a team to perform network-specific functions requested by the user. In performing the network-specific functions, the various computing devices may produce blocks that store the data generated during the performance of the network-specific functions and may add the blocks to the blockchain. After the block has been added to the blockchain, the wallet associated with the user may indicate that the requested network-specific function has been performed.

For example, a user may have a wallet which reflects that the user has five tokens associated with the decentralized P2P system. The user may provide a request to the decentralized P2P system to transfer the five tokens to a friend who also has a wallet. The various computing devices forming the decentralized P2P computing system may perform the request and transfer the five tokens from the wallet of the user to the wallet of the friend. In doing so, a block may be created by the various computing devices of the decentralized P2P computing system. The block may store data indicating that the five tokens were transferred from the wallet of the user to the wallet of the friend. The various computing devices may add the block to the blockchain. At such a point, the wallet of the user may reflect the transfer of the five tokens to the wallet of the friend, and may indicate a balance of zero. The wallet of the friend, however, may also reflect the transfer of the five tokens and may have a balance of five tokens. Similarly, additionally to and/or in place of transferring data (e.g., the tokens), the wallets may process functions associated with data transfer rules (e.g., business rules, data security policies, and/or the like.

In more detail, the decentralized P2P system may be specialized for the purpose of managing a distributed ledger, such as a private blockchain or a public blockchain, through the implementation of digital cryptographic hash functions, consensus algorithms, digital signature information, and network-specific protocols and commands. The decentralized P2P system (e.g., decentralized system) may be comprised of decentralized system infrastructure consisting of a plurality computing devices, either of a heterogeneous or homogenous type, which serve as network nodes (e.g., full nodes and/or lightweight nodes) to create and sustain a decentralized P2P network (e.g., a decentralized network such as the computing environment 100 and/or the distributed ledger computing systems 124). Each of the full network nodes may have a complete replica or copy of a blockchain stored in memory and may operate in concert, based on the digital cryptographic hash functions, consensus algorithms, digital signature information, and network-specific protocols, to execute network functions and/or maintain inter-nodal agreement as to the state of the blockchain. Each of the lightweight network nodes may have at least a partial replica or copy of the blockchain stored in memory and may request performance of network functions through the usage of digital signature information, hash functions, and network commands. In executing network functions of the decentralized network, such as balance sheet transactions and smart contract operations, at least a portion of the full nodes forming the decentralized network may execute the one or more cryptographic hash functions, consensus algorithms, and network-specific protocols to register a requested network function on the blockchain. In some instances, a plurality of network function requests may be broadcasted across at least a portion of the full nodes of the decentralized network and aggregated through execution of the one or more digital cryptographic hash functions and by performance of the one or more consensus algorithms to generate a single work unit (e.g., block), which may be added in a time-based, chronological manner to the blockchain through performance of network-specific protocols.

While in practice the term “blockchain” may hold a variety of contextually derived meanings, the term blockchain, as used herein, refers to a concatenation of sequentially dependent data elements (e.g., blocks) acting as a data ledger that stores records relating to a decentralized computing system. Such data records may be related to those used by a particular entity or enterprise, such as a financial institution, and/or may be associated with a particular application and/or use case including, but not limited to, cryptocurrency, digital content storage and delivery, entity authentication and authorization, digital identity, marketplace creation and operation, internet of things (IoT), prediction platforms, balloting activities, health information, currency exchange and remittance, P2P transfers, ride sharing, electronic entertainment, trading platforms, and real estate, precious metal, and work of art registration and transference, among others. A “private blockchain” may refer to a blockchain of a decentralized private system in which only authorized computing devices are permitted to act as nodes in a decentralized private network and have access to the private blockchain. In some instances, the private blockchain may be viewable and/or accessible by authorized computing devices which are not participating as nodes within the decentralized private network, but still have proper credentials. A “public blockchain” may refer to a blockchain of a decentralized public system in which any computing devices may be permitted to act as nodes in a decentralized public network and have access to the public blockchain. In some instances, the public blockchain may be viewable and/or accessible by computing devices which are not participating as nodes within the decentralized public network.

Further, a “full node” or “full node computing device,” as used herein, may describe a computing device in a decentralized system which operates to create and maintain a decentralized network, execute requested network functions, and maintain inter-nodal agreement as to the state of the blockchain. In order to perform such responsibilities, a computing device operating as a full node in the decentralized system may have a complete replica or copy of the blockchain stored in memory, as well as executable instructions for the execution of hash functions, consensus algorithms, digital signature information, network protocols, and network commands. A “lightweight node,” “light node,” “lightweight node computing device,” or “light node computing device” may refer to a computing device in a decentralized system, which operates to request performance of network functions (e.g., balance sheet transactions, smart contract operations, and the like) within a decentralized network but without the capacity to execute requested network functions and maintain inter-nodal agreement as to the state of the blockchain. As such, a computing device operating as a lightweight node in the decentralized system may have a partial replica or copy of the blockchain. In some instances, network functions requested by lightweight nodes to be performed by the decentralized network may also be able to be requested by full nodes in the decentralized system.

“Network functions” and/or “network-specific functions,” as described herein, may relate to functions which are able to be performed by nodes of a decentralized P2P network. In some arrangements, the data generated in performing network-specific functions may or may not be stored on a blockchain associated with the decentralized P2P network. Examples of network functions may include “smart contract operations.” A smart contract operation, as used herein, may describe one or more operations performed by a “smart contract,” which may be one or more algorithms and/or programs associated with one or more nodes within a decentralized P2P network. For example, the one or more algorithms and/or programs may correspond to addition of a NFT-API to a blockchain or querying of NFT-APIs stored in a blockchain. Addition of NFT-APIs may correspond to updating those stored in the blockchain.

In one or more aspects of the disclosure, a “digital cryptographic hash function,” as used herein, may refer to any function which takes an input string of characters (e.g., message), either of a fixed length or non-fixed length, and returns an output string of characters (e.g., hash, hash value, message digest, digital fingerprint, digest, and/or checksum) of a fixed length. Examples of digital cryptographic hash functions may include BLAKE (e.g., BLAKE-256, BLAKE-512, and the like), MD (e.g., MD2, MD4, MD5, and the like), Scrypt, SHA (e.g., SHA-1, SHA-256, SHA-512, and the like), Skein, Spectral Hash, SWIFT, Tiger, and so on. A “consensus algorithm,” as used herein and as described in further detail below, may refer to one or more algorithms for achieving agreement on one or more data values among nodes in a decentralized network. Examples of consensus algorithms may include proof of work (e.g., PoW), proof of stake (e.g., PoS), delegated proof of stake (e.g., DPoS), practical byzantine fault tolerance algorithm (e.g., PBFT), and so on. Furthermore, “digital signature information” may refer to one or more private/public key pairs and digital signature algorithms which are used to digitally sign a message and/or network function request for the purposes of identity and/or authenticity verification. Examples of digital signature algorithms which use private/public key pairs contemplated herein may include public key infrastructure (PKI), Rivest-Shamir-Adleman signature schemes (e.g., RSA), digital signature algorithm (e.g., DSA), Edwards-curve digital signature algorithm, and the like. A “wallet,” as used herein, may refer to one or more data and/or software elements (e.g., digital cryptographic hash functions, digital signature information, and network-specific commands) that allow a node in a decentralized P2P network to interact with the decentralized P2P network. A wallet may be associated with a public key, which may serve to identify the wallet. In requesting performance of network operations, a private key associated with the wallet may be used to digitally sign the network operation requests.

For another example, a first lightweight node computing device may request a smart contract operation related to a decentralized P2P network, which may facilitate a dual data transfer between a wallet associated with the first lightweight node computing device and a wallet associated with another node in the decentralized P2P network, such as the second lightweight node computing device, based on fulfillment of programmatic conditions established by a smart contract. Processors of the first lightweight node computing device may execute network commands to broadcast a smart contract operation network function request to the decentralized P2P network. The smart contract operation network function request may include details about the data transfer such as data type, function operations, and/or amount, as well as a data transfer amount to one or more full node computing devices of the decentralized P2P network for executing the smart contract corresponding to the smart contract operation network function request. The smart contract operation network function request may further include the public key associated with the smart contract. Processors of the first lightweight node computing device may execute digital signature algorithms to digitally sign the smart contract operation network function request with the private key associated with the wallet of the first lightweight node computing device.

At the decentralized P2P network, the smart contract operation network function request may be broadcasted to each of the full node computing devices through execution of network protocols by the full node computing devices. In order to execute the smart contract operation network function request and maintain inter-nodal agreement as to the state of the blockchain (or other distributed ledger structure), processors, ASIC devices, and/or GPUs of the full node computing devices may execute network protocols to receive broadcast of the network function through the decentralized P2P network and from the first lightweight node computing device. Processors, ASIC devices, and/or GPUs of the full node computing devices may execute hash functions to generate a digest of the smart contract operation network function request. The resultant digest of the smart contract operation network function request, in turn, may be hashed with the block hash of the most immediately preceding block of the blockchain. Processors, ASIC devices, and/or GPUs of the full node computing devices may execute consensus algorithms to identify a nonce corresponding to the particular executed consensus algorithm and related to the digest that combines the digest of the smart contract operation network function request and the block hash of the most immediately preceding block of the blockchain.

The identification of the nonce enables processors, ASIC devices, and/or GPUs of the full node computing device from the full node computing devices to create a new block with a block header (e.g., block hash), which is a digest that combines the smart contract operation network function request, the block hash of the most immediately preceding block, and the identified nonce. Processors, ASIC devices, and/or GPUs of the full node computing device from the full node computing devices may execute network protocols to add the new block to the blockchain and broadcast the new block to the other full node computing devices in the decentralized P2P network. In some arrangements, the new block may also be time-stamped at a time corresponding to the addition to the blockchain. Furthermore, as a reward for adding the new block to the blockchain, the full node computing device from the full node computing devices may, per the network protocols, increase a balance sheet holdings amount associated with itself by a predetermined amount. In some arrangements, each of the full node computing devices may receive an equal portion of the data transfer amount specified by the first lightweight node computing device for executing the smart contract operation network function request. After the new block has been added to the blockchain, the smart contract operation request may be considered to be executed and the data transfer from the wallet associated with the first lightweight node computing device to the public key associated with the smart contract may be registered.

The smart contract may be configured to hold the data transfer from the wallet associated with the first lightweight node computing device until fulfillment of certain predetermined criteria hardcoded into the smart contract are achieved. The smart contract may be configured such that it serves as an intermediate arbiter between entities within the decentralized P2P network and may specify details of a dual data transfer between entities, perform functionality and/or rules configured in the smart contract, and/or the like.

For example, the smart contract corresponding to the smart contract operation request may be one or more algorithms and/or programs stored on a block of the blockchain. The smart contract may be identified by one or more wallets and/or public keys within the decentralized P2P network. The first lightweight node computing device may transmit the smart contract operation network function request to the decentralized P2P network, which may cause execution of the corresponding smart contract that facilitates a dual data transfer between a wallet associated with the first lightweight node computing device and a wallet associated with another node in the decentralized P2P network, such as the second lightweight node computing device, based on fulfillment of programmatic conditions established by the smart contract. In the processes of adding the block comprising the smart contract operation request to the blockchain, each of the full node computing devices may identify the block within the blockchain comprising the smart contract, associate the data transfer entailed by the smart contract operation request with the smart contract, and execute the one or more algorithms and/or programs of the smart contract. In this instance, given that the smart contract facilitates a dual data transfer and that data transfer has yet to be received from another node (e.g., a lightweight node computing device), each of a plurality of full node computing devices may execute the smart contract without fulfillment of the programmatic conditions established by the smart contract. Accordingly, the funds transferred by the first lightweight node computing device may remain in the smart contract until the data transfer from the other node is also associated with the smart contract.

Moving forward, the second lightweight node computing device may also request a smart contract operation related to the decentralized P2P network, which may conclude the dual data transfer between the wallet associated the second lightweight node computing device and the wallet associated with the first lightweight node computing device. Processors of the second lightweight node computing device may execute network commands to broadcast the smart contract operation network function request to the decentralized P2P network. The smart contract operation network function request may include details about the data transfer such as data type and amount, as well as a data transfer amount to the full node computing devices of the decentralized P2P network for executing the smart contract corresponding to the smart contract operation network function request. The smart contract operation network function request may further include the public key associated with the smart contract. Processors of the second lightweight node computing device may execute digital signature algorithms to digitally sign the smart contract operation network function request with the private key associated with the wallet of the second lightweight node computing device.

At the decentralized P2P network, the smart contract operation network function request may be broadcasted to each of the full node computing devices through execution of network protocols by the full node computing devices. In order to execute the smart contract operation network function request and maintain inter-nodal agreement as to the state of the blockchain, processors, ASIC devices, and/or GPUs of the full node computing devices may execute network protocols to receive broadcast of the network function through the decentralized P2P network and from the second lightweight node computing device. Processors, ASIC devices, and/or GPUs of the full node computing devices may execute hash functions to generate a digest of the smart contract operation network function request. The resultant digest of the smart contract operation network function request, in turn, may be hashed with the block hash of the most immediately preceding block of the blockchain. Processors, ASIC devices, and/or GPUs of the full node computing devices may execute consensus algorithms to identify a nonce corresponding to the particular executed consensus algorithm and related to the digest that combines the digest of the smart contract operation network function request and the block hash of the most immediately preceding block of the blockchain.

The identification of the nonce enables processors, ASIC devices, and/or GPUs of the full node computing device from the full node computing devices to create a new block with a block header (e.g., block hash), which is a digest that combines the smart contract operation network function request, the block hash of the most immediately preceding block, and the identified nonce. Processors, ASIC devices, and/or GPUs of the full node computing device from the full node computing devices may execute network protocols to add the new block to the blockchain and broadcast the new block to the other full node computing devices in the decentralized P2P network. In some arrangements, the new block may also be time-stamped at a time corresponding to the addition to the blockchain. Furthermore, as a reward for adding the new block to the blockchain, the full node computing device from the full node computing devices may be allowed, per the network protocols, to increase a balance sheet holdings amount associated with itself by a predetermined amount. In some arrangements, each of the full node computing devices may receive an equal portion of the data transfer amount specified by the second lightweight node computing device for executing the smart contract operation network function request. After the new block has been added to the blockchain, the smart contract operation transaction network function request may be considered to be executed and the data transfer from the wallet associated with the second lightweight node computing device to the public key associated with the smart contract may be registered.

When the smart contract receives the data value from each of the second lightweight node computing device and the first lightweight node computing device, the execution of the smart contract by each of the full node computing devices may cause transfer of the data value from the second lightweight node computing device to the first lightweight node computing device and the data value from the first lightweight node computing device to the second lightweight node computing device.

For example, the second lightweight node computing device may transmit the smart contract operation network function request to the decentralized P2P network, which may cause execution of the corresponding smart contract that facilitates the dual data transfer. In the process of adding the block comprising the smart contract operation request provided by the second lightweight node computing device to the blockchain, each of the full node computing devices may identify the block within the blockchain comprising the smart contract, associate the data transfer entailed by smart contract operation request of the second lightweight node computing device with the smart contract, and execute the one or more algorithms and/or programs of the smart contract. In this instance, given that the smart contract facilitates a dual data transfer and that data transfers have been received from the second lightweight node computing device and the first lightweight node computing device, each of the full node computing devices may execute the smart contract as fulfillment of the programmatic conditions established by the smart contract has occurred. Accordingly, the funds allocated to the smart contract by each of the second lightweight node computing device and the first lightweight node computing device may be respectively distributed to the intended counterparty.

While the description provided above was made in relation to the second lightweight node computing device and the first lightweight node computing device, it should be understood that any of the full node computing devices and lightweight node computing devices in a decentralized system, such as the distributed ledger computing systems 124 and/or the computing environment 100, may participate in the smart contract. Furthermore, it should be understood that the smart contract may be able to fulfill dual data transfers in the manner described above across a plurality of entities entering into the smart contract. For example, a first plurality of entities may enter into the smart contract, which may hold the data values for each of the first plurality of entities until a second plurality of entities enter into the smart contract. When each of the first plurality of entities and the second plurality of entities have entered, the smart contract may perform the data transfer. Other smart contracts may be included which include algorithms, programs, and/or computer-executable instructions which cause the performance of one or more functions related to at least cryptocurrency, digital content storage and delivery, entity authentication and authorization, digital identity, marketplace creation and operation, internet of things (e.g., IoT), prediction platforms, balloting information, health information, currency exchange and remittance, P2P transfers, ride sharing, electronic information, trading platforms, and real estate, precious metal, and work of art registration and transference.

In one or more arrangements, the AI model vulnerability testing system 104, the application computing systems 108, the client computing systems 122, the client computing systems 120, the distributed ledger computing systems 123, the user devices 110, the databases 116 and/or the other devices/systems in the computing environment 100 may be any type of computing device capable of receiving input via a user interface, and communicating the received input to one or more other computing devices in the computing environment 100. For example, the AI model vulnerability testing system 104, the application computing systems 108, the client computing systems 122, the client computing systems 120, the distributed ledger computing systems 123, the user devices 110, the databases 116, and/or the other devices/systems in the computing environment 100 may, in some instances, be and/or include server computers, desktop computers, laptop computers, tablet computers, smart phones, wearable devices, or the like that may comprised of one or more processors, memories, communication interfaces, storage devices, and/or other components. Any and/or all of the AI model vulnerability testing system 104, the application computing systems 108, the client computing systems 122, the client computing systems 120, the distributed ledger computing systems 123, the user devices 110, the databases 116, and/or the other devices/systems in the computing environment 100 may, in some instances, be and/or comprise special-purpose computing devices configured to perform specific functions.

FIG. 1B shows an illustrative AI model vulnerability testing system 104 in accordance with one or more examples described herein. The AI model vulnerability testing system 104 may be a stand-alone device and/or may at least be partial integrated with the AI model vulnerability testing system 104 may comprise one or more of host processor(s) 155, medium access control (MAC) processor(s) 160, physical layer (PHY) processor(s) 165, transmit/receive (TX/RX) module(s) 170, memory 150, and/or the like. One or more data buses may interconnect host processor(s) 155, MAC processor(s) 160, PHY processor(s) 165, and/or Tx/Rx module(s) 170, and/or memory 150. The AI model vulnerability testing system 104 may be implemented using one or more integrated circuits (ICs), software, or a combination thereof, configured to operate as discussed below. The host processor(s) 155, the MAC processor(s) 160, and the PHY processor(s) 165 may be implemented, at least partially, on a single IC or multiple ICs. The memory 150 may be any memory such as a random-access memory (RAM), a read-only memory (ROM), a flash memory, or any other electronically readable memory, or the like.

Messages transmitted from and received at devices in the computing environment 100 may be encoded in one or more MAC data units and/or PHY data units. The MAC processor(s) 160 and/or the PHY processor(s) 165 of the AI model vulnerability testing system 104 may be configured to generate data units, and process received data units, that conform to any suitable wired and/or wireless communication protocol. For example, the MAC processor(s) 160 may be configured to implement MAC layer functions, and the PHY processor(s) 165 may be configured to implement PHY layer functions corresponding to the communication protocol. The MAC processor(s) 160 may, for example, generate MAC data units (e.g., MAC protocol data units (MPDUs)), and forward the MAC data units to the PHY processor(s) 165. The PHY processor(s) 165 may, for example, generate PHY data units (e.g., PHY protocol data units (PPDUs)) based on the MAC data units. The generated PHY data units may be transmitted via the TX/RX module(s) 170 over the private network 125. Similarly, the PHY processor(s) 165 may receive PHY data units from the TX/RX module(s) 165, extract MAC data units encapsulated within the PHY data units, and forward the extracted MAC data units to the MAC processor(s). The MAC processor(s) 160 may then process the MAC data units as forwarded by the PHY processor(s) 165.

One or more processors (e.g., the host processor(s) 155, the MAC processor(s) 160, the PHY processor(s) 165, and/or the like) of the AI model vulnerability testing system 104 may be configured to execute machine readable instructions stored in memory 150. The memory 150 may comprise (i) one or more program modules/engines having instructions that when executed by the one or more processors cause the AI model vulnerability testing system 104 to perform one or more functions described herein and/or (ii) one or more databases that may store and/or otherwise maintain information which may be used by the one or more program modules/engines and/or the one or more processors. The one or more program modules/engines and/or databases may be stored by and/or maintained in different memory units of the AI model vulnerability testing system 104 and/or by different computing devices that may form and/or otherwise make up the AI model vulnerability testing system 104. For example, the memory 150 may have, store, and/or comprise a real time model analysis engine 150-1, a scoring engine 150-2, a response engine 150-3, and/or the like. The real time model analysis engine 150-1 may have instructions that direct and/or cause the AI model vulnerability testing system 104 to perform one or more operations associated with performing real-time security testing of AI models before each time the AI model is accessed, such as capturing an input to initiate operation of the AI application or otherwise cause the AI application to use the AI model, and the like. The scoring engine 150-2 may have instructions that may cause the AI model vulnerability testing system 104 to analyze AI model vulnerability testing results, calculate a vulnerability score and/or a trust score, and to provide output identifying the same. The response engine 150-3 may have instructions that may cause the AI model vulnerability testing system 104 to coordinate a response based on the vulnerability score and/or trust score, and the like.

While FIG. 1A illustrates the AI model vulnerability testing system 104, the user devices 110, and/or the application computing systems 108, as being separate elements connected in the private network 125, in one or more other arrangements, functions of one or more of the above may be integrated in a single device/network of devices. For example, elements in AI model vulnerability testing system 104 (e.g., host processor(s) 155, memory(s) 150, MAC processor(s) 160, PHY processor(s) 165, TX/RX module(s) 170, and/or one or more program/modules stored in memory(s) 150) may share hardware and software elements with and corresponding to, for example, the AI model vulnerability testing system 104, the user devices 110, and/or the application computing systems 108.

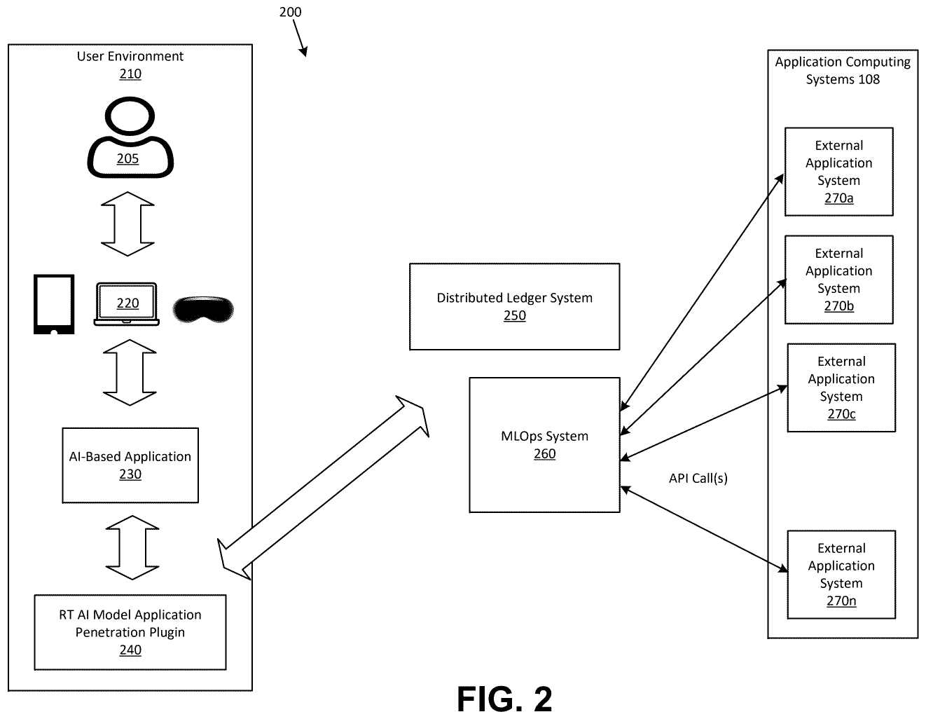

FIG. 2 shows illustrative real-time AI model vulnerability testing system 200 in accordance with one or more aspects described herein. In some cases, the real-time AI model vulnerability testing system 200 may include a user environment 210, a distributed ledger system 250, a machine learning operations (MLOps) system 260, one or more application computing systems 108, such as the external application system 270a-n. The user environment 210 may allow a user 205 to interact with an AI-based application 230 on one or more user devices 220. The user devices 220 may execute instructions to access the AI-based application 230, operate the AI-based application, utilize a remote AI-based application, and/or a combination. A real-time AI model application penetration plugin 240 may be installed on a user device and may initiate an analysis of one or more AI models that may be utilized by the AI-based application 230. The real-time AI model application penetration plugin 240 may be installed on one or more user devices 220 (e.g., a computing machine, a personal computer, a mobile computing device, a spatial computing device, and/or the like). The real-time AI model application penetration plugin 240 interacts with the AI-based application 230 to orchestrate a security scan prior to all transactions (e.g., data exchange sessions, electronic financial transactions, and/or the like) and/or tasks executed by the AI-based application 230.

In some cases, the real-time AI model application penetration plugin 240 (e.g., a real-time AI model scanning plugin) may integrate with the AI-based application 230 to facilitate interaction between the real-time AI model application penetration plugin 240 and the AI-based application 230. In some cases, the real-time AI model application penetration plugin 240 may comprise a framework within which at least a portion of the AI-based application 230 executes or otherwise operates. In such cases, the real-time AI model application penetration plugin 240 facilitates user 205 interaction with the AI-based application 230, such that the real-time AI model application penetration plugin 240 may manage and/or intercept the commands that may result in AI model use by the AI-based application. For example, the real-time AI model application penetration plugin 240 may initiate the real-time scan before releasing the user request input to the AI-based application.

The MLOps system 260 may comprise an automated computing system that manages or otherwise coordinates machine learning model testing and/or release, where automated systems may machine learning models to production, and then maintaining and monitoring the AI models. The MLOps system 260 may facilitate functionality for developing, training, releasing, monitoring, and/or retraining AI models. For example, the MLOps system 260 may facilitate exploratory data analysis the allows the system to iteratively prepare information for use in training data sets, such as by defining and producing reproducible, editable, and/shareable datasets. The MLOps system 260 may transform, aggregate and/or de-duplicate data retrieved from multiple sources, including, in some cases real-time data collection while the AI model is being used. Additionally, the MLOps system 260 may train and improve model performance via one or more model training libraries, automated machine learning tools to perform trial runs and/or to create deployable code. Additionally, the MLOps system 260 may be used to manage model lineage information, model versioning information, model artifact information, and/or transitions through the model lifecycle. The MLOPs system 260 may be used to manage the frequency of model refresh, inference request times and similar production-specifics in testing and QA. Use CI/CD tools such as repos and orc/or model testing processes to enable efficient model deployment and monitoring activities.

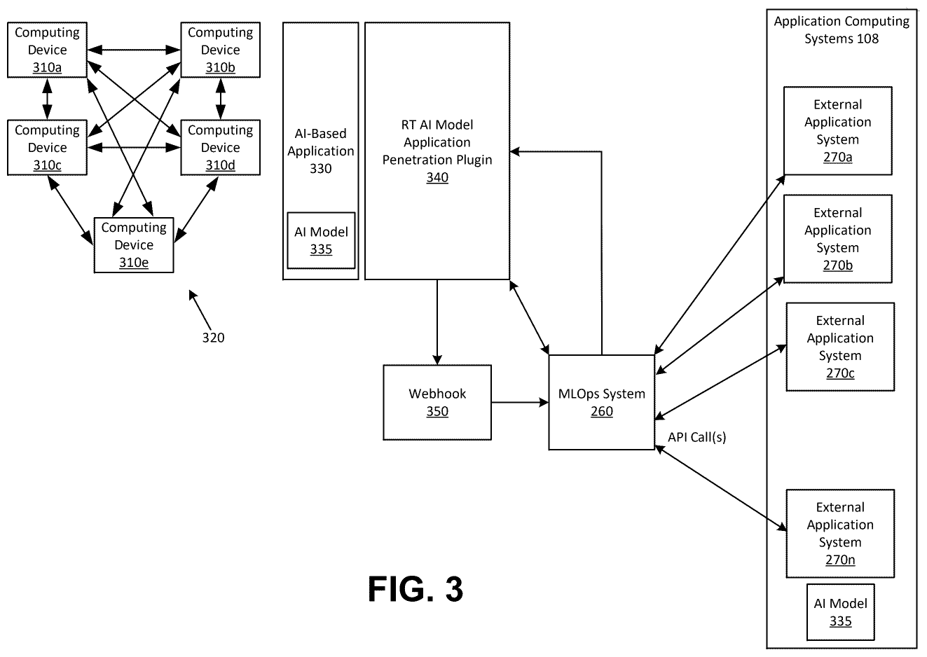

FIG. 3 show an illustrative localized network-based real-time AI model vulnerability testing system, in accordance with one or more example arrangements. The real-time AI model vulnerability testing system performs a process that allows the user 205 to integrate their computing devices 310a-310e (e.g., user devices 110, user devices 220, and the like) to each of the other user devices 310a-310e to form a local area network 320 that can be used to relay or otherwise coordinate trust scores with the other user devices 310a-310e. Each user device 310a-310e can engage other user devices 310a-310e having similar AI-based application 330 and/or utilizing a same AI model to enable performance of a joint penetration test that may be linked to the specific AI-based application 330 and/or a particular AI model. The process may enable one or more of the computing devices 310a-310e to trigger a webhook call to an AI model development system, such as the MLOps system 260 via a webhook system 350 based on the trust score generated based on penetration test analysis. The webhook system 350 may enable sending of webhooks or other automated requests triggered by a source system (e.g., the real-time AI model application penetration plugin 340) to a destination system (e.g., the MLOps system 260) to automatically provide payload data from the source system to the destination system. In some cases, the webhook may be enabled via a hypertext transfer protocol (HTTP) webhook request, the receipt of the webhook may cause the MLOps system 260 to perform an action, such as by triggering a penetration test and/or a penetration test result analysis.

The process enables each user device 310a-310e to trigger a webhook call 350 to AI model development central system (e.g., the MLOps system 260), as needed, based on a score (e.g., a vulnerability score, a trust score, and the like) generated thru penetration testing results. A webhook payload may include penetration testing result metadata that can be utilized by the MLOps system 260 for resolving a vulnerability and/or other security issue. In some cases, the process may enable the MLOps system 260 to ingest the webhook payload, extract the webhook payload including penetration testing metadata, and automatically generate healing protocols by leveraging neuro-symbolic AI. Based on the webhook payload parameters provided, the MLOps system 260 may interact with a neuro-symbolic AI system to automatically generate patches, or other code to resolve an identified vulnerability.

An automated AI model analysis process may begin with a real-time AI model application penetration plugin 340 installed on each computing device of the user devices 310a-310e performing a scan. The real-time AI model application penetration plugin 340 may then extract device details from the scan information and/or scan metadata to generate a device profile. The real-time AI model application penetration plugin 340 interacts with an AI model 335 utilized by the AI-based application 330, where the AI model 335 is hosted at a client device and/or at a server-side device (e.g., on an application computing system 180). The real-time AI model application penetration plugin 340 extracts data and metadata telemetry associated with AI model functioning and/or resources (such as, but not limited to, cache information, API use information, end point information, training data information, training data source information, computing infrastructure information, data storage server information, edge computing infrastructure information, information associated with additional software application(s) supporting model execution, and/or the like). Using the extracted information, the real-time AI model application penetration plugin 340 may generate an MLOps profile corresponding to the AI model.

Data extracted by the real-time AI model application penetration plugin 340 is parsed and sent to a neuro-symbolic AI engine that may enhance penetration test cases and/or generate new penetration testing protocols, data sets, scenarios, and/or test cases. The generated penetration test cases, scenarios or conditions may be utilized (e.g., executed) in real-time, and synchronized with, a computing device on which the particular AI model 335 is hosted and/or that is accessing a remotely hosted AI model 335. The results of the penetration testing may be converted to an AI Model trust score by the real-time AI model application penetration plugin 340 and analyzed in real time, such as by being compared to a trust threshold.

If a trust score is less than defined threshold value, the real-time AI model application penetration plugin 340 may trigger a webhook event 350 to trigger an event at a central AI model development system, such as the MLOps system 260. In some cases, following a comparison to one or more threshold values, the real-time AI model application penetration plugin 340 may generate a security alert to one or more of the computing devices 310a-310e, such as via a visualization screen, an audio alert, and/or the like. In some cases, if the trust value meets a specified threshold, the real-time AI model application penetration plugin 340 may limit use of the AI model 335 and/or disable functioning of the AI-based application 330. In some cases, the real-time AI model application penetration plugin 340 may generate a smart contract that includes penetration testing rules and/or condition, for use with future scans such as when a device profile and/or an AI product profile changes. For example, when a profile change has been identified, the real-time AI model application penetration plugin 340 may trigger a new scan and generate a new trust score.

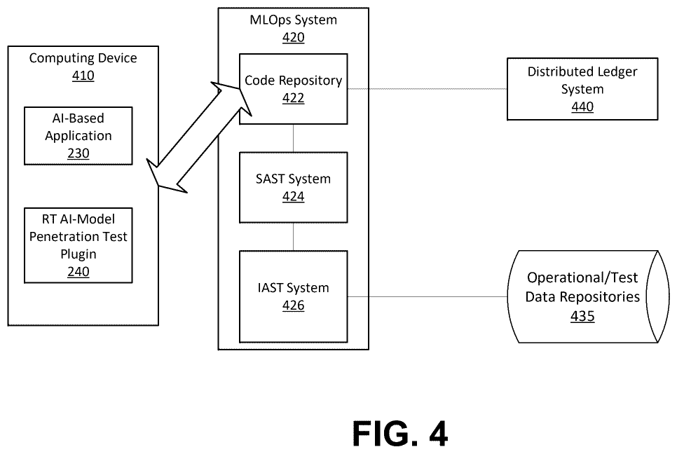

FIG. 4 shows an illustrative penetration testing system in accordance with one or more aspects described herein. A computing device 410 may utilize a model evaluation score that was generated based on details of penetration testing when evaluating whether an AI model utilized by the AI-based application is subject to one or more security vulnerabilities. In some cases, an MLOps system 420 may include a code repository, a static application security testing (SAST) system 424, an interactive application security testing (IAST) system 426) and may include, or have access to, one or more databases, such as operational and/or test data repositories 435. The MLOps system may be in communication with one or more computing devices, such as the computing device 410 and/or a distributed ledger computing system 440. In some cases, the real-time AI model penetration plugin 240 may receive a request to trigger an action by an AI-based application and may trigger a penetration test to be performed by an external system, such as the MLOps system 420. The real time AI model penetration test plugin 240 may identify versions of software plugins and/or applications used to identify possible vulnerabilities in the ML and/or AI software. In some cases, automated penetration testing may focus on performance of prompt injection testing, either direct or indirect, of the AI model. The testing system may further analyze AI model output for obfuscation indicators. In some cases, the testing system may compare the output, such as to expected output data sets, to identify a model leak (e.g., model proxy). In some cases, the testing system may analyze a volume of queries pushed to the AI model, and identify whether the AI model responds by restrict the load, such as in a denial of service attack.

In some cases, a penetration testing engine may scan the code of an application, and/or an AI model algorithm to identify the vulnerability in the code and/or a plugin to identify vulnerabilities in libraries and modules that may be used for structured query language (SQL) injection, cross-site scripting, command injection, a hardcoded password, a secret key, clear text for a password, unsafe functions (e.g., eval( ).exec( ), an API path accessed, and/or the like. The penetration testing engine may have access to a model endpoint and identify whether the AI model is used for privilege and/or whether the AI model is role-based or not. For example, an illustration of penetration testing may include identifying prompt-override avenues that may give access to an application host system environment and/or an API key that may be mitigated with filtering a prompt and rotation of API keys. The penetration test may extract a functional copy of a private model, such as by repeatedly querying a machine learning (ML) Inference API thereby performing model-proxying and/or using the model for other types of attack, which may be mitigated by ML output obfuscation and/or restricting a number of ML queries. The penetration test engine may further test the behavior of the model for direct penetration and/or prompt injection via a data channel, text, or multimedia where a malicious prompt may be hidden or obfuscated. Further, the penetration test engine may test the model for its capability to identify adversarial inputs and/or atypical queries that deviate from known behavior of the model.

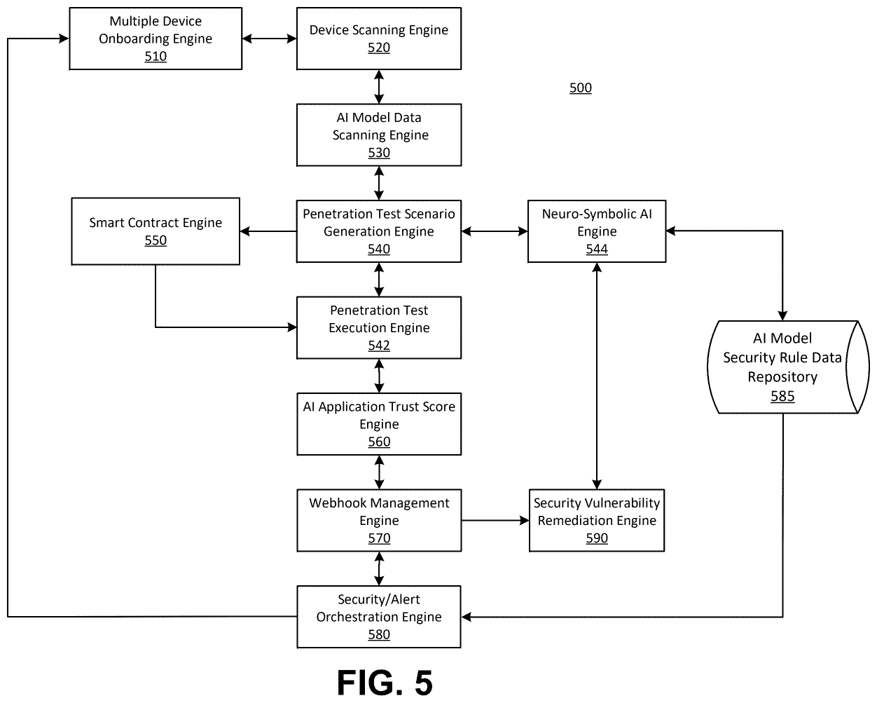

FIG. 5 shows an illustrative block diagram of an AI model penetration testing system 500 in accordance with one or more aspects described herein. The illustrative AI model penetration testing system 500 may include one or more of a multiple device onboarding engine 510, a device scanning engine 520, an AI model data scanning engine 530, a penetration test scenario generation engine 540, a penetration test execution engine 542, a neuro-symbolic AI engine 544, a smart contract engine 550, an AI application trust score engine 560, a webhook management engine 570, a security/alert orchestration engine 580, an AI model security rule data repository 585, a security vulnerability remediation engine 590, and/or the like.

The multiple device onboarding engine 510 may gather information from one or more user devices (e.g., user devices 110, user devices 220, one or more of the computing devices 310a-310e, computing device 410, and/or the like). The gathered information may be received by and/or from the installed real time AI model penetration test plugin 240 via a communication. In some cases, the multiple device onboarding engine 510 may be integrated within the real time AI model penetration test plugin 240 or may be located on a remote device, such as the MLOps system 260. The multiple device onboarding engine 510 may generate device configuration files, application configuration files, AI model configuration files based on the onboarding information gathered from the user device and/or the AI-based applications. These configuration files may be used by one or more engines to facilitate device scans, AI model tests, AI-based application events (e.g., allowing or disabling AI model functionality based on AI model test results), and/or the like.

The device scanning engine 520 may be integrated within the real time AI model penetration test plugin 240 and may utilize information (e.g., configuration files) gathered or otherwise created by the multiple device onboarding engine 510. The device scanning engine 520 may initiate a scan of one or more devices based on input request(s) from one or more users (e.g., the user 205) to use functionality of the AI-based application 230 that may utilize one or more AI models (e.g., the AI model 335). The device scanning engine 520 may receive AI model scanning information from the AI model data scanning engine 530 that may cause the device scanning engine 520 to initiate an AI model scan (e.g., data indicating that the AI model has been updated or has not been scanned recently by another device) or to cancel or pause an AI model scan (e.g., based on information identifying that the AI model has been scanned recently by one or more user devices, where the recent scan is within a threshold time range (e.g., 100 milliseconds, 30 seconds, 1 minute, 5 minutes, and the like). The AI model data scanning engine 530 may utilize one or more penetration test scenarios, test cases, test data sets and/or the like that may be generated by the penetration test scenario generation engine 540 when scanning the AI model.

The penetration test scenario generation engine 540 coordinates and/or incorporates the neuro-symbolic AI engine 544 and/or the penetration test execution engine 542. The penetration test scenario generation engine 540 may generate new penetration tests based on identified vulnerabilities with the AI model, AI-based application, malicious attack patterns, vulnerabilities identified with network infrastructure hardware, firmware, and/or software, application vulnerability information, neuro-symbolic AI analysis results, and/or the like. In some cases, existing penetration tests may be adjusted or otherwise modified based on AI model data and/or webhook payload information received from the real-time AI model application penetration plugin 240. The penetration test execution engine 542 may execute one or more penetration tests in real-time based on a triggering event received from the real-time AI model application penetration plugin 240, such as for a requested use of one or more AI models by the AI-based application 230.

The neuro-symbolic AI engine 544 may include a datastore that may be actively built and/or updated in real-time based on the neuro-symbolic assessment of AI model operations including API function calls triggered by AI model operation based on inputs received from applications and/or computing systems requesting access to data within the enterprise network. The neuro-symbolic AI engine 544 may utilize a neural network (e.g., a deep neural network) and a symbolic reasoning architecture to provide an artificial intelligence-based system capable of reasoning, learning and cognitive modeling. The neuro-symbolic AI engine 544 may include one or more different neuro-symbolic architectures, such as symbolic neural symbolic, symbolic [neural], neural|symbolic, neural:symbolic->neural, Neural_{symbolic], neural[symbolic], and/or the like. Each of the above approaches may utilize different neural network architectures and/or symbolic reasoning processes to perform the neural-symbolic operations and is a non-exhaustive list. Many approaches have been used to provide a decisioning system that operates similarly to how a human makes decisions. For example, certain neuro-symbolic architectures may utilize vector-symbolic architectures to combine learning representations provided by neural networks with compositional aspects of multi-dimensional and/or distributed vectors. The neuro-symbolic AI engine 544 may utilize additional parameter-based assessment that may be combined with neural network processing and symbolic reasoning to perform user validation based on user information collected from the AI models, API function calls, application information, and/or webhook payload information. Additional symbols, such as those stored in a symbol validation datastore may be used as indicators for identify validation. In some cases, the symbol information may be retrieved from the MLOps system 260, where the symbols may be used by the customer access pattern engine to identify different behavioral patterns based on user activity information, where symbols may be mapped by the symbol mapper 366 to consumer behavioral patterns and may be stored in and/or compared to patterns stored in a model behavioral assessment repository.

The smart contract engine 550 may coordinate execution of the penetration tests by the penetration test execution engine 542, based on smart contract operations triggered by AI model use inputs received from the real-time AI model application penetration plugin 240. In some cases, a new smart contract may be generated by the smart contract engine 550 and stored as a block in a block chain of one or more distributed leger systems, based on information received form the penetration test scenario generation engine 540. In some cases, the smart contract engine 550 may utilize the information received form the penetration test scenario generation engine 540 with one or more smart contract blockchains associated with a user device, a group of user devices, an AI model, related AI models, and/or an AI-based application. In some cases, the smart contract engine 550 may coordinate penetration test operation with the penetration test execution engine 452 based on smart contract execution, where the choice of penetration tests run for particular AI models and/or AI model conditions (e.g., user device, user location, device location, model type, application type, application operations, requested and/or utilized data, and/or the like) may be determined based on functions or functionality embedded in the smart contract.

The penetration test execution engine 542 coordinates real-time testing of the AI model based on inputs received, where penetration testing results are analyzed by the AI application trust score engine 560. The AI application trust score engine 560 generates a trust score based on the results of the penetration test results that may, or may not, include a weighted combination with one or more previously calculated trust scores. In some cases, an AI model use by an AI application that passes a penetration test may have a high trust score, while each portion of a failed or unknown result of the penetration test may combine to reduce the trust score for the AI model use by particular applications. In some cases, if an AI model is shared by multiple applications, the trust score for each of the sharing applications may be impacted (e.g., a weighted combination) with trust score values of the other applications. In some cases, the AI application trust score engine 560 may be incorporated into the real-time AI model application penetration plugin 240.

The real-time AI model application penetration plugin 240 may use the trust value to enable and/or disable use of the AI model and/or the AI application. For example, if a trust score fails to meet a first trust threshold (e.g., a low trust score such as 1/10 or 2/10, and the like), the real-time AI model application penetration plugin 240 may block operation of the AI-based application. If the trust score falls between the first trust threshold and a second trust threshold (e.g., a mid-range trust score such as 4/10, 5/10, 6/10, and/or the like) one or more AI enabled features provided by the AI application via AI model use may be suspended or otherwise paused. When the trust score meets or exceeds a third trust score (e.g., a higher-level trust score such as 7/10, 8/10, 9/10 and/or the like), the real-time AI model application penetration plugin 240 may allow the AI-based application 330 to run as expected. A vulnerability score may be output in addition to or in place of a trust score, where vulnerability thresholds may be used by the real-time AI model application penetration plugin 240 to determine whether to disable, partially enable or fully enable the AI-based application's use of the AI model.

The webhook management engine 570 may manage creation and sending of webhooks, or other system messages, where the message payload information provides information corresponding to a local device conditions, configuration, model versioning, AI-based application information including configuration and usage information, and/or the like. The webhook management engine 570 may provide information to the security/alert orchestration engine 580 and/or the security vulnerability remediation engine 590 to trigger alerts to one or more user devices including, but not limited to, the user device using the AI-based application and AI model triggering the alert, user devices within a local network of that device, and/or one or more other user devices using the AI-based application and/or the AI model causing the alert. The security/alert orchestration engine 580 may orchestrate a coordinated response to an identified alert, such as by proactively disabling the AI model across the enterprise network and/or in identified installations associated with a real-time AI model application penetration plugin 240. The security vulnerability remediation engine 590 may receive the payload information corresponding to the identified vulnerability as well as neuro-symbolic analysis information used to generate the penetration tests and/or the penetration tests to allow the security vulnerability remediation engine 590 to automatically identify the vulnerability, analyze the information concerning the vulnerability, and generate one or more potential remedial actions to resolve the vulnerability (e.g., improvements to AI model training sets and/or removing invalid data from AI model training data sets) and/or to improve vulnerability identification abilities. The AI model security rule repository may store one or more penetration test cases or scenarios, security rule code associated with one or more enterprise networks, AI model analysis information, and/or the like.

One or more aspects of the disclosure may be embodied in computer-usable data or computer-executable instructions, such as in one or more program modules, executed by one or more computers or other devices to perform the operations described herein. Generally, program modules include routines, programs, objects, components, data structures, and the like that perform particular tasks or implement particular abstract data types when executed by one or more processors in a computer or other data processing device. The computer-executable instructions may be stored as computer-readable instructions on a computer-readable medium such as a hard disk, optical disk, removable storage media, solid-state memory, RAM, and the like. The functionality of the program modules may be combined or distributed as desired in various embodiments. In addition, the functionality may be embodied in whole or in part in firmware or hardware equivalents, such as integrated circuits, application-specific integrated circuits (ASICs), field programmable gate arrays (FPGA), and the like. Particular data structures may be used to more effectively implement one or more aspects of the disclosure, and such data structures are contemplated to be within the scope of computer executable instructions and computer-usable data described herein.

Various aspects described herein may be embodied as a method, an apparatus, or as one or more computer-readable media storing computer-executable instructions. Accordingly, those aspects may take the form of an entirely hardware embodiment, an entirely software embodiment, an entirely firmware embodiment, or an embodiment combining software, hardware, and firmware aspects in any combination. In addition, various signals representing data or events as described herein may be transferred between a source and a destination in the form of light or electromagnetic waves traveling through signal-conducting media such as metal wires, optical fibers, or wireless transmission media (e.g., air or space). In general, the one or more computer-readable media may be and/or include one or more non-transitory computer-readable media.

As described herein, the various methods and acts may be operative across one or more computing servers and one or more networks. The functionality may be distributed in any manner, or may be located in a single computing device (e.g., a server, a client computer, and the like). For example, in alternative embodiments, one or more of the computing platforms discussed above may be combined into a single computing platform, and the various functions of each computing platform may be performed by the single computing platform. In such arrangements, any and/or all of the above-discussed communications between computing platforms may correspond to data being accessed, moved, modified, updated, and/or otherwise used by the single computing platform. Additionally, or alternatively, one or more of the computing platforms discussed above may be implemented in one or more virtual machines that are provided by one or more physical computing devices. In such arrangements, the various functions of each computing platform may be performed by the one or more virtual machines, and any and/or all of the above-discussed communications between computing platforms may correspond to data being accessed, moved, modified, updated, and/or otherwise used by the one or more virtual machines.

Aspects of the disclosure have been described in terms of illustrative embodiments thereof. Numerous other embodiments, modifications, and variations within the scope and spirit of the appended claims will occur to persons of ordinary skill in the art from a review of this disclosure. For example, one or more of the steps depicted in the illustrative figures may be performed in other than the recited order, and one or more depicted steps may be optional in accordance with aspects of the disclosure.

1. A system comprising:
a host computing device hosting an artificial intelligence (AI) model management system, wherein an AI model managed by the AI model management system;
a computing device, comprising:
a processor; and
memory storing computer-readable instructions that, when executed by the processor, cause the computing device to:
enable a real-time AI model scanning plugin monitoring operations of an AI-based application, wherein the AI-based application comprises the AI model;
capture, by the real-time AI model scanning plugin, a first command to the AI-based application;
trigger, by the real-time AI model scanning plugin, a real-time penetration test of the AI model by the host computing device, wherein the host computing device calculates a trust score based on results of the real-time penetration test; and
disable, based on a trust score meeting a first threshold, operation of the AI-based application.

2. The system of claim 1, wherein the host computing device comprises a machine learning operations (MLOps) system.

3. The system of claim 1, wherein the real-time AI model scanning plugin comprises a plugin to the AI-based application.

4. The system of claim 1, wherein the real-time AI model scanning plugin comprises a framework within which the AI-based application operates.

5. The system of claim 1, wherein the first command comprises a command to enable operation of the AI model.

6. The system of claim 1, wherein the instructions cause the computing device to partially disable, based on the trust score meeting a second threshold condition, a set of operations of the AI-based application wherein the first command requests an operation of the set of operations.

7. The system of claim 1, wherein the instructions cause the API route testing platform to enable, based on the trust score meeting a third threshold condition, unrestricted operation the AI-based application in response to the first command.

8. A method comprising:
enabling, on a user device, a real-time AI model scanning plugin that monitors operations of an AI-based application, wherein the AI-based application comprises an AI model;
capturing, by the real-time AI model scanning plugin, a first command to the AI-based application;
triggering, by the real-time AI model scanning plugin, a real-time penetration test of the AI model by a host computing device, wherein the host computing device calculates a trust score based on results of the real-time penetration test;
disabling, based on the trust score meeting a first threshold, operation of the AI-based application; and
capturing, by the real-time AI model scanning plugin, a next command to the AI-based application and repeating the triggering and disabling steps in real-time.

9. The method of claim 8, wherein the host computing device comprises a machine learning operations (MLOps) system.

10. The method of claim 8, wherein the real-time AI model scanning plugin comprises a plugin to the AI-based application.

11. The method of claim 8, wherein the real-time AI model scanning plugin comprises a framework within which the AI-based application operates.

12. The method of claim 8, wherein the first command comprises a command to enable operation of the AI model.

13. The method of claim 12, further comprising partially disabling, based on the trust score meeting a second threshold condition, a set of operations of the AI-based application wherein the first command requests an operation of the set of operations.

14. The method of claim 13, further comprising enabling, based on the trust score meeting a third threshold condition, unrestricted operation the AI-based application in response to the first command.

15. Non-transitory computer readable media storing instructions that, when executed by a processor, cause a computing device to:
enable a real-time AI model scanning plugin monitoring operations of an AI-based application, wherein the AI-based application comprises an AI model;
capture, by the real-time AI model scanning plugin, a first command to the AI-based application;
trigger, by the real-time AI model scanning plugin, a real-time penetration test of the AI model by a host computing device, wherein the host computing device calculates a trust score based on results of the real-time penetration test; and
disable, by the real-time AI model scanning plugin, based on a trust score meeting a first threshold, operation of the AI-based application.

16. The non-transitory computer readable media of claim 15, wherein the host computing device comprises a machine learning operations (MLOps) system.

17. The non-transitory computer readable media of claim 16, wherein the real-time AI model scanning plugin comprises a plugin to the AI-based application.

18. The non-transitory computer readable media of claim 15, wherein the real-time AI model scanning plugin comprises a framework within which the AI-based application operates.

19. The non-transitory computer readable media of claim 15, wherein the instructions cause the computing device to disable, based on the trust score meeting a second threshold condition, a set of operations of the AI-based application wherein the first command requests an operation of the set of operations.

20. The non-transitory computer readable media of claim 15, wherein the instructions cause the computing device to enable, based on the trust score meeting a third threshold condition, unrestricted operation the AI-based application in response to the first command.
